(19) United States
(12) Patent Application Publication
(10) Pub. No.: US 2003/0136846 A1
(43) Pub. Date: Jul. 24, 2003

(54) Optical memory card, method of manufacture, and driver for card

(76) Inventors: Timothy C. Higgins, Campbell, CA (US); Vladimir A. Knyazik, Palo Alto, CA (US); Michael H. Ngo, San Jose, CA (US); Arnold O. Thornton, San Jose, CA (US)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/057,452

(22) Filed: Jan. 22, 2002

(51) Int. Cl. G06K 19/00; G06K 19/06

(52) U.S. Cl. 235/487

(57) ABSTRACT

An optical memory card including a substrate with a data zone covered by an information carrying layer, at least one diffractive optical element (DOE) that is positioned on the substrate, and a metal element coupled to the substrate. The data zone advantageously has a small inner radius, e.g., 12 mm. The DOE may be embossed in the substrate within the data zone formed on the substrate. The metal element may include a hole or protrusion to align the card with a driver. A method for making the card includes embossing a substrate with DOE and grooves, and provides an information carrying layer. A driver for the memory card including a magnetic chuck and a reading laser.

### FIELD OF THE INVENTION

The invention relates to a data storage carrier in the form of a card, and more particularly to an optical data storage card that optionally comprises diffractive optical elements embossed within the card for additional security.

### BACKGROUND

Many types of memory card are in use today. Memory cards are used to store information and data for a wide range of applications, such as identification, personal medical data, security, bank, and access cards. There is also a wide range of storage media implemented in these various memory cards.

The most abundant example of a memory card is the ordinary plastic credit card or identification card shown in FIG. 1 as memory card 10. FIG. 1 shows the side of the memory card 10 containing the storage media, generally referred to as the backside of memory card 10. On the backside of memory card 10 a magnetic stripe 12 is positioned for magnetically storing data. The data stored on the magnetic stripe 12 typically verifies the written or embossed information on the front side of the card and may include additional information or data.

Magnetic stripe memory card 10, while inexpensive to manufacture and issue, provides relatively little security against counterfeiting because of the simple manufacturing steps involved in making memory card 10. Further, memory card 10 offers little security against unauthorized or fraudulent access to the information stored on the exposed magnetic stripe, since such information can be easily read or altered using commonly available equipment. Additionally, the recorded data on the magnetic stripe may be distorted or destroyed by dirt, scratches, or contact of the magnetic stripe with magnetic materials. Moreover, the capacity of such a magnetic stripe plastic card is limited to about 0.5 KB to 1.7 KB, or about 70 to 200 alphanumeric characters. On the opposite side or front side of memory card 10 (not shown in FIG. 1), memory card 10 may have embossed lettering to indicate the identity of the holder, an identification, or account number and possibly other information to notify the user of the possible content of the card.

Another type of card, known as an optical memory card, is similar to the magnetic-stripe plastic card 10 but replaces the magnetic stripe 12 with a stripe of reflective material. Information is stored in the optical memory card by burning microscopic holes in the surface of the reflective stripe with a focused, low-power laser. Optical memory cards for data storage are well known. Such cards may be distinguished from electronic or flash memory cards that rely upon non-volatile integrated circuit chips to retain data. Optical memory cards also have a plurality of uses ranging from identification cards to credit cards.

A typical optical memory card is capable of higher data storage capacities than magnetic stripe cards. For example, an optical memory card may have a storage capacity of up to 2-5 MB. However, the storage capacity of such optical memory cards is still insufficient for many desired uses. Further, typical optical memory cards do not provide adequate protection against unauthorized access to the data stored in the exposed reflective stripe or inhibiting the counterfeit production of such cards. Again, manufacturing these cards and accessing the stored information on them is relatively simple.

One type of optical media with greater capacity than known memory cards are CD disks. CD disks are well known as a storage medium on which data and programs, such as system software or computer games can be stored permanently during the production of the CD disk. The most widespread embodiment of the CD disk is one that is only once writeable and therefore designated a CD-ROM or CD-R. The memory content of such a CD disk, hereinafter referred to as data or information, can be read out completely but not changed. In particular, no data can be added and no temporary data stored on the CD disk. CD disks are also available that can be rewritten and therefore designated a CD-RW. The memory content of a CD-RW can be read out and may also be added to. In particular, data can be added and temporarily stored on the CD-RW by rewriting data on the disk on empty tracks or over previously stored data. Although a CD disk offers greater data storage capacity than the magnetic stripe memory cards or conventional optical memory cards they have several drawbacks. In particular they lack sufficient methods of inhibiting counterfeiting and unauthorized uses that is also a problem with the magnetic stripe cards and optical memory cards. Additionally, CD storage disks have a fairly large spindle or center hole for mounting and spinning the CD disk when reading the stored data. This large spindle hole limits the amount of data that can be stored on the CD disk.

Thus a high capacity optical memory card is desired with small physical dimensions similar to known memory cards. It is also desired to ensure the authenticity of the memory cards and further inhibit the counterfeiting of the memory cards with a high level of security.

### SUMMARY

According to one embodiment of the present invention, an optical memory card includes a substrate having a data zone and an information carrying layer formed on the substrate, at least one diffractive optical element that is positioned in the substrate, and a metal element coupled to the substrate.

The optical memory card may further include a protective layer formed over the information carrying layer and the diffractive optical elements. The information layer may include a reflective layer, CD-R layer, CD-RW layer, collectively referred to as a CD layer or a DVD-R or DVD-RW layer, collectively referred to as a DVD layer, and may have an inner radius of approximately 12 mm. The diffractive optical elements may be embossed in the substrate and positioned either within or outside of the data zone formed on the substrate. A metal element may be centrally located on the substrate and may further include a hole or protrusion to align the memory card with a driver.

According to another embodiment of the present invention, a memory card including a substrate with an data zone encircling the center of the substrate and covered with an information carrying layer and a metal element centrally located on the substrate.

According to another embodiment of the present invention, a memory card including a substrate with a data zone covered by an information carrying layer formed on said substrate and at least one diffractive optical element on the substrate.

According to another embodiment of the present invention, a method for creating a memory card includes embossing a substrate layer with a desired diffractive optical element design, embossing the circular grooves for an information carrying layer on a substrate, and providing an information carrying layer over the embossed grooves. The diffractive optical element can be embossed within or outside of the pattern of embossed grooves.

According to another embodiment of the present invention, a driver for reading a memory card comprising a magnetic chuck driven by a motor, where the memory card is magnetically held adjacent to the magnet chuck, and a reading laser. As the motor rotates the magnetic chuck the memory card is also rotated. The driver may further include a light source positioned to create a light beam incident upon a diffractive optical element of the memory card and a detector positioned to receive the light diffracted from the diffractive optical element. The driver may further include a small protrusion, hole, or hole to engage with and center the memory card and a reading laser for reading information stored on the memory card.

According to another embodiment of the present invention, a driver for reading and authenticating a memory card comprising a magnetic chuck driven by a motor, a reading laser, and a light source positioned to create a light beam incident upon a diffractive optical element of the memory card and a photodetctor positioned to receive light diffracted from said diffractive optical element.

The present invention is better understood upon consideration of the detailed description below and the accompanying drawings.

### BRIEF DESCRIPTION OF THE DRAWINGS

FIG. 1 shows a conventional magnetic or optical stripe memory card.

FIG. 2A shows the first side of an optical memory card according to an embodiment of the present invention.

FIG. 2B shows the second side of an optical memory card according to an embodiment of the present invention.

FIG. 2C shows a cross-sectional view of an optical memory card according to an embodiment of the present invention.

FIGS. 3A, 3B, and 3C show a respective top view, side view, and a more detailed side view of a section of an optical memory card in accordance with one embodiment of the present invention.

FIGS. 4A, 4B, 4C, and 4D show cross-sectional views of possible configurations of a metal element located near the center of an optical memory card.

FIGS. 5A and 5B show possible configurations of metal elements and holes or holees of an optical memory card.

FIGS. 6A and 6B show the first side of optical memory cards according to alternate embodiments of the present invention.

FIGS. 7A, 7B, 7C, and 7D illustrate how a photomask used in the manufacturing of a master DOE in a quartz wafer is created according to one embodiment of the present invention.

FIGS. 8A, 8B, 8C, and 8D illustrate how a photomask is used to manufacture a master DOE in a quartz wafer according to one embodiment of the present invention.

FIGS. 9A, 9B, 9C, 9D, and 9E illustrate how the optical memory card is embossed according to one embodiment of the present invention.

FIG. 10 shows a driver apparatus to read an optical memory card according to one embodiment of the present invention.

FIG. 11 shows a magnetic chuck with a protrusion to magnetically hold and align an optical memory card in accordance with an embodiment of the present invention.

FIG. 12 shows another embodiment of a magnetic chuck with a protrusion to magnetically hold and align an optical memory card.

In the present disclosure, like objects which appear in more than one figure are provided with like reference numerals.

### DETAILED DESCRIPTION

An optical memory card, in accordance with an embodiment of the present invention, includes a substrate with an information carrying optical layer formed on the substrate, e.g., over a data zone. In one embodiment, the optical memory card does not use a center spindle hole as found in conventional CD disks which, advantageously, provides more area on the optical memory card for storing data. In another embodiment, a small center hole is provide on the optical memory card, e.g., for alignment purposes.

To mount and read the optical memory card in a reader, one or more small metal elements may be coupled to the card which are magnetically held to the reader's chuck. In another embodiment, the optical memory card is clamped by an upper and lower chuck pairs that include magnets. One of the chuck pairs may included, a center spindle that protrudes through the center hole in the optical memory card for alignment.

Further, to increase the security of the cards, one or more diffractive optical elements may be added to the optical memory card. The diffractive optical elements may be produced in a single stamping process whereby both the grooves required for the data zone, which is covered by the information carrying layer, and the diffractive optical element patterns are embossed into the substrate. The diffractive optical element may be stamped within the grooves for additional security. The optical memory card of the present invention may use CD-R, CD-RW, DVD, or DVD-RW, collectively, CD or DVD, or any other appropriate optical formats.

A method for manufacturing an optical memory card according to an embodiment of the present invention includes embossing a substrate layer with desired diffractive optical element design and the grooves. The diffractive optical elements and grooves may be embossed with a single negative mold stamp. An information carrying layer is then provided over the embossed grooves. A driver for authenticating an optical memory card according to an embodiment of the present invention includes a magnetic chuck that magnetically holds and spins the memory card and a light source that is positioned to direct light off of the diffractive optical elements and detect their diffraction patterns.

FIGS. 2A, 2B, and 2C show the first side, second side, and a cross-sectional view respectively of an optical memory card according to one embodiment of the present invention. FIG. 2A shows the first side of an optical memory card, referred to herein as CD card 100. It should be understood that while the optical memory card is referred to as CD card 100, other appropriate formats, e.g. DVD, may be used. CD card 100 has a rectangular shape with slightly rounded corners representing roughly the shape of a standard credit card or drivers license. Of course, the shape of CD card 100 can be chosen to be any convenient size. In this embodiment the shape of CD card 100 is chosen to fit easily into a wallet or purse. In this embodiment CD card 100 has a length L of approximately 86 mm, a width W of approximately 54 mm, and a thickness T (shown in FIG. 2C) of approximately 0.75 mm. Other sized cards are clearly possible within the scope of the present invention, including different geometric shapes and different physical sizes.

On the first side of CD card 100 (shown in FIG. 2A) a data zone 111 is covered by a reflective information carrying layer 110 in the form of a circular ring and is centered on CD card 100. In this embodiment of CD card 100, the information carrying layer consists of a CD-R layer. CD-R storage media is well known in the art. The substrate of CD card 100 may be made of a polycarbonate substrate or other suitable substrate for forming therein groves that serve as information tracks and guides for a reading laser to follow and read out the data. CD-R media further contains a reflective surface with a layer of optically active dye on the grooved polycarbonate substrate. The optically active dye is typically an organic dye such as cyanine. Lasers are used to write on the surface by deforming or melting the optical dye layer to create pits and lands within the spiral grooves. The pits and lands represent the binary data stored on the disk. A reading laser beam is then reflected off the disk or card to detect the pits and lands located within the spiral or concentric grooves. The difference between the reflected light from the lands and pits is then interpreted as a binary signal.

The data zone 111 and information carrying layer 110 are positioned in such a way as to maximize the data storage capacity within the dimensions of the CD card 100. The storage capacity is proportional to the area of the data zone 111. Therefore, the outer diameter 112 of data zone 111 is positioned to be as close to or equal to the width W of CD card 100 such that the data zone 111 approaches the edge of CD card 100. This allows for the maximum area and thus capacity for the dimensions of CD card 100.

In one embodiment, CD card 100 does not use a center spindle hole or trench line of a conventional CD disk. By not using a center spindle hole or trench line, which conventionally is located at a radius of 19.25 mm on a standard CD, the data zone 111 can have a smaller inner radius 114 and thus cover more area. By increasing the area of the data zone 111 the storage capacity of CD card 100 is increased, e.g., up to 50 MB. This is a substantial gain over conventional optical memory cards with storage capacity of around 2-5 MB. Thus, to maximize the total data storage capacity of CD-R disk 100, inner radius 114 of data zone 111 may be made smaller than a conventional CD disk.

It should be noted that the closer the data zone 111 is to the center, the smaller the circumference of the grove containing the data becomes, and thus only an increasingly smaller amount of storage capacity can be gained. Also, as the radius decreases, the CD card 100 must be spun faster to write or retrieve the data. These factors are all taken into account in determining the size of the inner radius. For example, a conventional CD-R disk may have the innermost data storage layer at a radius of approximately 24 mm and a center hole radius of 16 mm. According to one embodiment of the present invention the innermost track of the data storage layer is located at a radius of approximately 12 mm ±0.01 mm, which increases the storage capacity by approximately 20 MB relative to conventional devices.

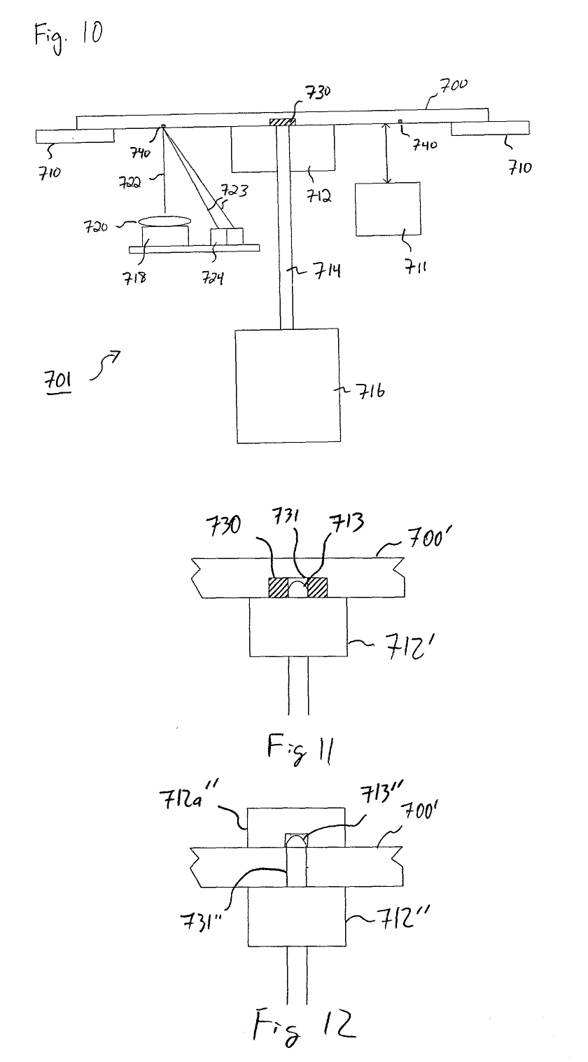

CD card 100 has a metal element 130 coupled to CD card 100 in the place of a center spindle hole. The metal element 130 is used to center and hold CD card 100 in a driver by the use of a magnetic chuck 712 located in the driver 701 (shown in FIG. 10). It should be understood that metal element 130 may also be used for other purposes, e.g., as an additional security element. For example, the resistivity of the metal element 130 may be tested as a security element.

Metal element 130 may be a steel disk or any other metal that can be held by a magnetic chuck. It should further be understood that metal element 130 may be shaped as a disk, square, rectangle, or any other shape. Metal element 130 may be coupled to the first or second surface of CD card 100. Metal element 130 may also be embedded fully or partially within the substrate of CD card 100.

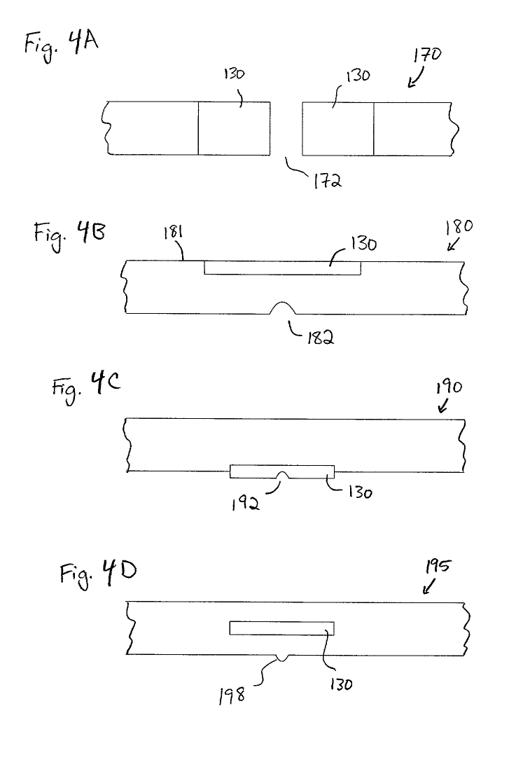

CD card 100 may also have a small hole that can serve to center and align the CD card 100 over the driver. It should be understood that the hole may extend all the way through the CD card 100 or only partially through CD card. Moreover, if desired, a protrusion may be used instead of a hole. The hole or protrusion may be formed in metal disk 130 or on a surface of a CD card located near the center of the CD card. FIGS. 4A-4C show cross-sectional views of possible configurations of a metal element 130 located near the center of a CD card. FIG. 4A shows CD card 170 according to one embodiment in which metal element 130 has a hole 172 formed through it. Hole 172 may extend fully or partially through metal element 130.

FIG. 4B shows another embodiment with metal element 130 located on a first or second surface of CD card 180. CD card 180 has a hole 182 formed on the opposite surface in which the metal element 130 is located. Hole 182 may alternatively be a protrusion extending away from the surface of CD card 180. Metal element 130 is shown flush with the surface 181 of CD card 180, but of course metal element 130 may be positioned on surface 181 or beneath the surface 181.

FIG. 4C shows yet another embodiment with metal element 130 located on a first or second surface of CD card 190. In this embodiment metal element 130 is partially embedded in CD card 190 and a hole 192 is formed within metal element 130.

FIG. 4D shows yet another embodiment with metal element 130 fully embedded within the body of CD card 195. Further shown in the embodiment is a protrusion 198 extending away from the body of CD card 195. In another embodiment a protrusion may also be formed extending away from metal portion 130 as opposed to the body of the CD card.

It should be understood, of course, that any combination of embodiments may be used in accordance with the present invention.

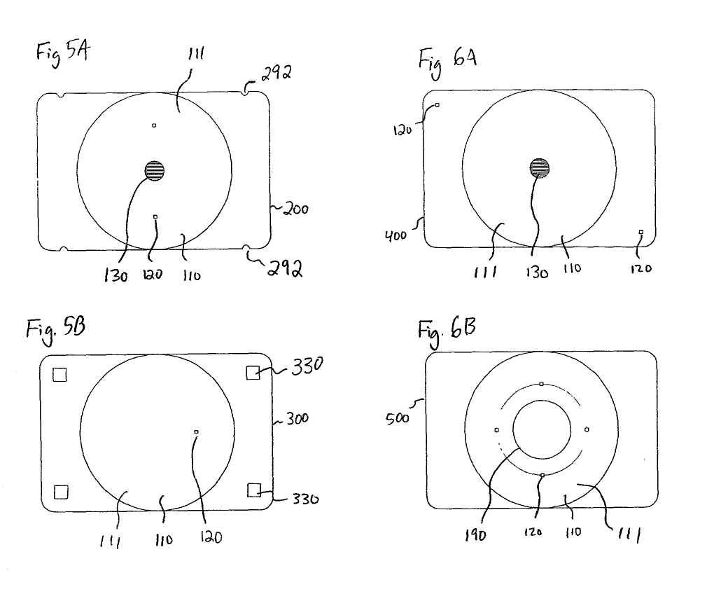

Alternatively, metal element 130 and/or one or more notches or protrusions may be located at non-center locations of the CD card. FIGS. 5A and 5B show possible configurations of a CD card with metal elements and notches that are not centrally located with the CD card. FIG. 5A shows CD card 200 with notches 292 located near the corners of CD card 200 and with the metal element 130 centrally located in CD card 200. Of course, more or fewer notches 292 may be used in CD card 200. FIG. 5B shows CD card 300 with metal elements 330 located near the corners of CD card 300. Of course, more or fewer metal elements 330 may be used in CD card 300.

Thus, with the large spindle hole of conventional driver replaced, an optical memory card of the present invention may be held and centered on magnetic chuck 712 with the cooperation of metal elements 130 or 330, and holes/notches 172, 182, 192, or 292. It should be understood that other combinations of metal elements, holes, notches and/or protrusions are possible with the present invention.

Referring back to FIG. 2A, CD card 100 according to one embodiment of the present invention may further include one or more diffractive optical elements (“DOE”) 120 embossed on the first or second side of CD card 100. DOE are optical elements that can be embossed, etched, or otherwise produced on the CD card. As is known in the art, DOE function to diffract incident light into many converging or diverging light beams. The manner in which the incident light is diffracted depends on the specific manufacture of the DOE. The light reflected from the DOE can then be detected with a photo detector in a conventional manner to determine how the DOE diffracts the incident light. It should be understood that DOE can have many different designs and therefore may diffract light in many different manners. Because DOEs can be created very small, it is advantageously very difficult to copy or reproduce them.

In one embodiment, the DOE 120 are embossed within the area of data zone 111 along a radius 122. In this manner the DOE are embossed at the substrate level within the spiral or circular grooves of the substrate. The DOE 120 provide the CD card 110 with a high level of security against counterfeiting and unauthorized access. Driver 701 (shown in FIG. 10) is configured to read the DOE embossed on the CD card 110 and determine if the CD card 100 is authentic. The driver focuses a laser with a collimating lens to the position where DOE 120 are expected to be positioned. The light reflected off from the DOE 120 is then detected by a quad photo detector. If the quad detector does not read DOE 120 or they are not the correct DOE designs the drive will be disabled and the CD card 100 will be inaccessible. Therefore, the purpose of the DOE 120 is to serve as a first level of security by ensuring that the CD card 100 is authentic by not allowing the drive to read the CD card 100 if the DOE are not read properly.

Additionally, placing DOE 120 within the spiral grooves at a known location creates even greater security for CD card 100. In particular, the location within the spiral grooves of substrate 166 makes it difficult for one to remove the DOE 120 from an authentic card and transfer them to a counterfeit card. The precise position of the DOE 120 within the grooves must be duplicated for the driver to recognize the CD card as authentic. Thus, because DOE 120 are both difficult to produce and difficult to transfer from an authentic CD card 100, they offer a very high level of security.

A second level of security may be achieved by reserving part of data zone 111 for additional security data such as encryption codes or other personal information entered by the user. This reserved area for storing additional security data may be non-rewritable memory to further deter and prevent counterfeiting and unauthorized access.

FIG. 2B shows the second side of CD card 100 according to one embodiment of the present invention. The surface 140 of the second side of CD card 100 may be used for purposes other than data storage, such as embossed lettering to indicate the identity of the holder, an identification or account number, advertising, and other information depending on the use and/or content of the card. Additionally, the front side of the card may also include a semiconductor chip 134 adhered or fixed to a surface of the CD card 100 and may activate a RF coil (not shown) also adhered or fixed to CD card 100. Additionally, a magnetic stripe (not shown) similar to that of FIG. 1 may be added.

FIG. 2C shows a cross-sectional view of one half of CD card 100 along A-A in FIG. 2A. Located in the center of CD card 100 is metal element 130 shown extending through the body of CD card 100. Metal element 130 may be placed on the first or second surface of CD card 100. Metal disk 130 may also be embedded fully or partially within the substrate of CD card 100, and may be thicker or thinner than the thickness T of CD card 100. Additionally metal plate 130 may include a hole or protrusion for centering the CD card 100 over the driver 701.

Substrate 166 forms the bottom layer of the CD card 100. The substrate 166 may be formed of a synthetic resin such as polycarbonate or other suitable material for forming an information carrying layer thereon. The top surface 167 of substrate 166 contains grooves that have been preformed during the manufacture of the substrate via a stamping or molding process as is well known. Substrate 166 also includes DOE 120, which may be either stamped or etched in the substrate 166. A reflective layer 164 is then applied on the top surface 167 of the substrate 166. The reflective layer 164 may comprise, for example, a sputtered gold or silver layer or an aluminum evaporated film of high reflectivity. A CD-R layer 162 is then coated on the surface of the reflective layer 164. CD-R layer 162 may be comprised of cyanine, phthalocyanine or any other organic dye suitable for CD-R media. A conventional overcoat 160 is then applied over the CD-R layer 162. Overcoat 160 serves to protect the CD-R layer 162 and/or the reflective layer 164 from abrasion and corrosion. The reflective layer 164 and overcoat 160 may coat the DOE 120 if desired.

In another embodiment, CD-R layer 162 may be layered on the top surface 167 of substrate 166 as is well known in the manufacturing of CD disks. In such an embodiment reflective layer 164 is then layered on the CD-R layer followed by the overcoat 160 to protect the reflective layer 164.

In the above-described embodiment, the CD card 100 has been shown as one where the information carrying layer 110 comprises a CD-R layer 162 and reflective layer 164. It should be understood, of course that the present invention can be likewise carried out with an information carrying layer comprising a rewriteable CD-RW layer or appropriate DVD format in combination with appropriate reflective coatings as is well know in the art. CD-RW, DVD-R, and DVD-RW layers would require slightly different layer configurations on substrate 166. For example, a CD-RW layer may replace the organic dye recording layer with a crystalline compound, which can be “erased” with a first temperature and “written on” with a second greater temperature, as is known in the art. Also, a structure suitable for DVD format would require additional layers and a smaller track pitch of the grooves which is also well known in the art.

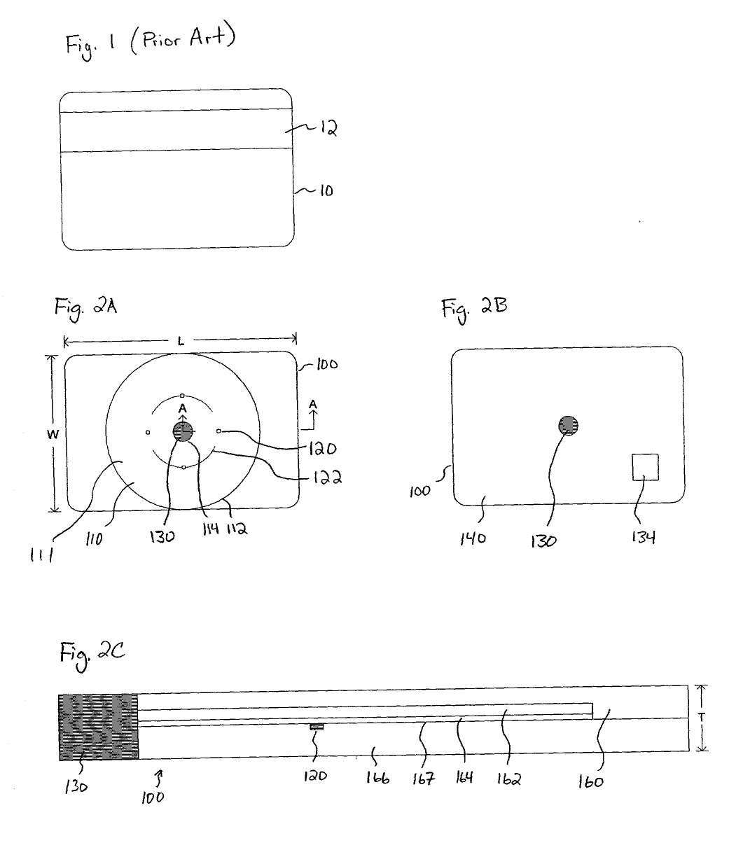

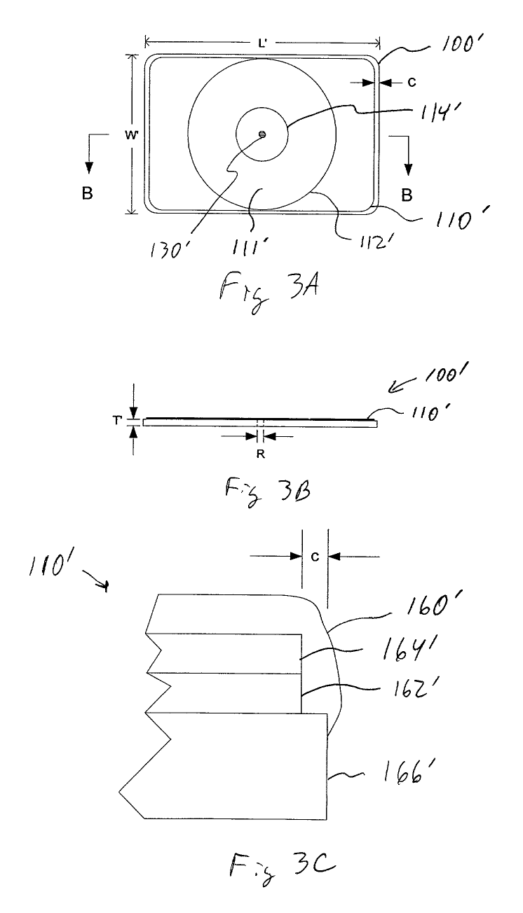

FIGS. 3A, 3B, and 3C show a respective top view, side view, and a more detailed side view of a section of a CD card 100′, in accordance with one embodiment of the present invention. CD card 100′ may have a length of approximately 85.5±0.2 mm, a width W of approximately 54.0±0.2 mm, and a thickness T (shown in FIG. 3B) of approximately 0.75±0.02 mm, which is similar to the dimensions L, W, and T, of CD card 100 in FIGS. 2A, 2B, and 2C. CD card 100′ has a data tack having at an inner radius 114′ of approximately 12.0±0.1 mm and an outer radius 112′ of approximately 26.0 ±0.1 mm. CD card 100′ includes a center hole 172′ that has a diameter D (shown in FIG. 3B) of approximately 3.0±0.1 mm. Center hole 172′ is used to assist in loading and alignment of the CD card 100′. Moreover, because of the small size of center hole 172′, conventional optical memory cards, which have larger spindle holes, cannot be used in place of the CD card 100′. The data zone 111′ on CD card 100′ extends from at least the inner radius 112′ and extends to a contour distance C of 0.25 mm to the edges of the CD card 100′.

As shown in FIG. 3B, which is a side view of CD card 100′ taken along lines B-B in FIG. 3A, substrate 166′ is covered by the information carrying layer 110′ to near the edges of the CD card 100′. FIG. 3C shows a more detailed side view of CD card 100′ with contour distance C between the information carrying layer 110′ and the edge of the card. The information carrying layer 110′, e.g., includes dye layer 162′ and a reflective layer 164′, such as silver. An overcoat 160′ then covers CD card 100′.

FIG. 6A shows the first side of CD card 400 according to another embodiment of the present invention. This embodiment includes data zone 111 and centrally located metal element 130. In CD card 400 the DOE are located outside of the data zone. If desired, DOE can also be placed on an opposite side of CD card 400. Positioning DOE 120 outside of the information containing grooves and information layer 120 adds to the storage capacity of CD card 400 because there is more area for the information layer 120. However, the level of security is compromised compared to CD card 100 because the DOE are not located at a known location within the grooves of CD card 100. Alternatively, the DOE's of CD card 400 may be removed from the card completely.

FIG. 6B shows the first side of CD card 500, according to another embodiment of the present invention. In this embodiment the DOE 120 of the CD card 500 are located within the data zone 111, however the CD card 500 has a conventional CD disk spindle hole 190 at the center. CD card 500 has the added security of CD card 100, namely that the DOE 120 are located within the information containing grooves. However, the level of storage capacity is compromised compared to CD card 100 and 400 because the conventional spindle hole 190 reduces the area of the data zone 111.

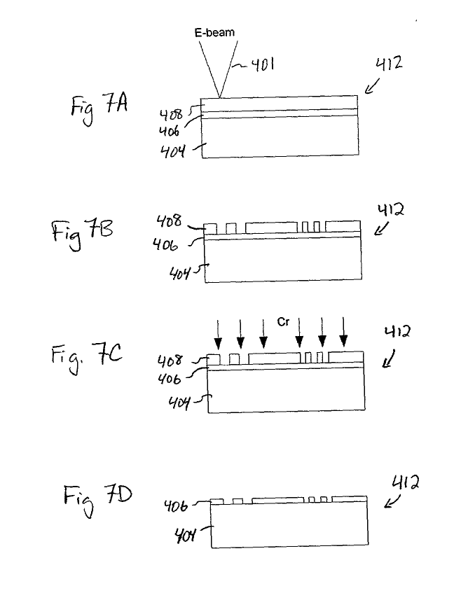

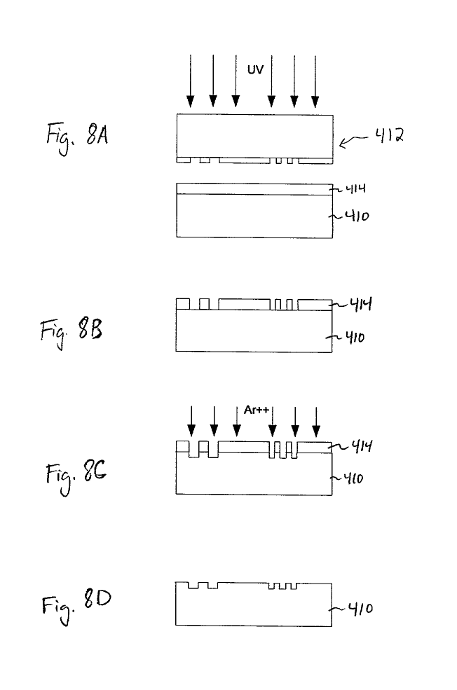

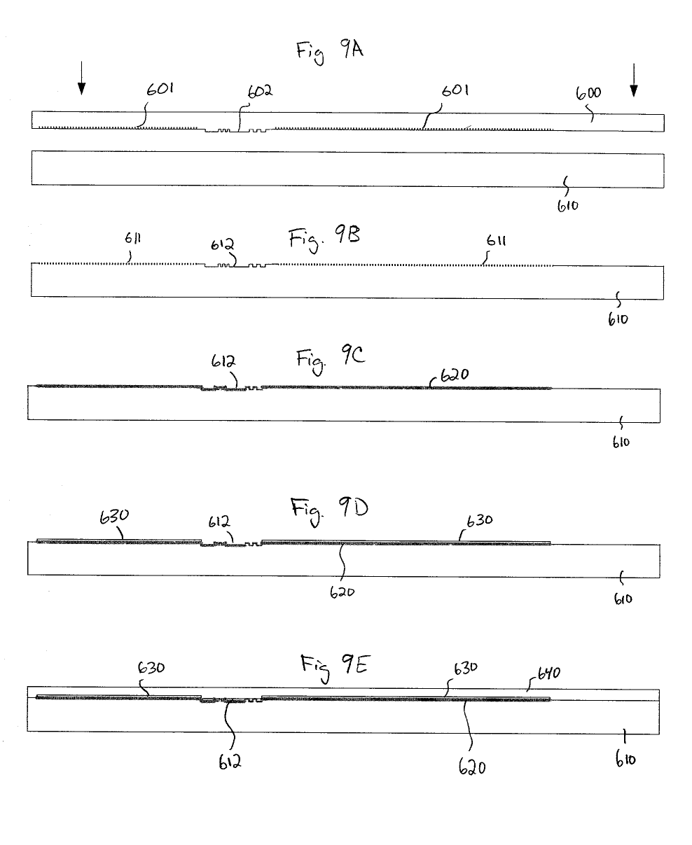

FIGS. 7A through 7D and FIGS. 8A through 8D illustrate how the master DOE elements are made in a quartz wafer. The master DOE is then used with a master nickel shim to create a stamp to emboss the substrate with the spiral or concentric grooves and the DOE patterns at the same time. First a photomask is manufactured using known techniques as shown in FIGS. 7A through 7D. FIG. 7A shows the photomask 412 consisting of substrate 404, mask layer 406, and a photo resist layer 408. An electron beam 401 etches photo resist layer 408. Other methods of etching resist layer 408 may be used, for example an ion beam, as is well known in the art. FIG. 7B shows photomask 412 after the resist layer 408 has been etched and photo resist layer 408 is developed. In FIG. 7C a chromium etch is performed on the photomask 412. Finally, the photo resist strip 408 is removed leaving the desired photomask 412.

FIGS. 8A through 8D illustrate how the photomask 412 created in FIGS. 7A through 7D is used to manufacture the master DOE element in a quartz wafer. In FIG. 8A the photomask 412 is positioned adjacent to the quartz wafer 410. The quartz wafer 410 has a resist layer 414 applied thereon. The quartz wafer 410 is then exposed to ultraviolet light that passes through the photomask 412 and is incident upon the resist layer 414. In FIG. 8B the resist layer 414 is developed. In FIG. 8C a reactive ion, such as Ar⁺⁺, or any other suitable reactive ion, etches the quartz wafer 410. In FIG. 8D the resist layer 414 is then removed and the quartz wafer 410 cleaned. In this manner a master DOE element in a quartz wafer may be manufactured. The quartz wafer will then be used to create the negative mold 600 (FIG. 9A).

The methods used for fabricating the master DOE elements are well known in the art, and other suitable methods may be used to create the master DOE element for use in the present invention.

FIGS. 9A through 9E illustrate the steps for embossing the CD card according to one embodiment of the present invention. FIGS. 9A through 9E show only one half of the CD card from the center region to the edge. FIG. 9A illustrates a negative mold 600 used to stamp substrate 610 with the grooves 601 and DOE element 602. The master DOE element formed in quartz wafer 410 is used to fabricate the DOE 602 formed in the negative mold 600 from a shim created through a known nickel electroplating processes. A stamp or negative mold 600 is then created from the nickel shim that that will stamp both the preformed grooves 611 and the DOE 612 on substrate 610. Thus, the DOE 612 are stamped at the substrate level of the CD cards according to this embodiment of the present invention.

FIG. 9B illustrates substrate 610 after being stamped by the negative mold 600 and extrusion of the embossed plastic has been completed. As shown, the stamp 600 forms DOE 612 within the grooves 611 of the substrate layer 610.

FIG. 9C illustrates substrate 610 after a reflective coating 620 is applied over the embossed grooves 611 and DOE 612. Metal coating 620 may be silver, gold, or any other highly reflective metal suitable for CD-R.

FIG. 9D illustrates substrate 610 after the CD-R layer 630 is applied on the reflective coating layer 620 to form the information carrying layer. CD-R layer 630 is applied over the reflective coating only above the areas of substrate 610 where the grooves 611 were stamped in FIG. 9A.

FIG. 9E illustrates the completed CD-card after overcoat layer 640 has been applied over the CD-R layer 630 and DOE 612. Protective layer 640 protects CD-R layer 630 and DOE 612 from scratches, corrosion, and other possible damage. Optionally ink or other embossed information can be added to the CD-card on the side opposite of protective layer 640.

FIG. 10 shows a block diagram of a driver for reading a CD card and the read-out set-up according to one embodiment of the present invention. CD disk drivers are well known in the art so only the differences in the driver of the present invention will be described in detail. As is also known in the art, a driver rotates a chuck to spin the CD card at an appropriate speed to read data from the data zone 111.

A CD card 700 according to one embodiment of the present invention is centered over the driver 701 and supported by platform 710. CD card 700 can be manually placed in this position or otherwise oriented by known drive trays. Magnetic chuck 712 of the drive 701 holds CD card 700 securely in place against the platform 710 through the attraction of metal disk 730 located centrally on or within CD card 700. Motor 716 turns spindle 714 that in turn rotates magnetic chuck 712 and CD disk 700 at a desired speed of revolution. Magnetic chuck 712 can be a toroid magnet or any other magnet suitable for use in driver 701.

Magnetic chuck 712 and/or spindle 714 may include a small protrusion, or hole that engages the CD card 700 or metal disk 730 to aid in the initial alignment and centering of the CD disk over the center of drive 701. In addition, metal disk 730 may include a small protrusion, or hole that engages the magnetic chuck 712 or spindle 714 for the same purposes. In this manner the CD card 700 is held and aligned and driven by driver 701 with out the need for the large spindle hole of known CD disks. For example, FIG. 11 shows a block diagram of chuck 712′ holding card 700′ (only a portion is shown in FIG. 11), which includes a metal element 730′ with a hole 731. As shown in FIG. 11, chuck 712′ includes a protrusion 713 that engages hole 731 to ensure alignment of card 700′.

FIG. 12 shows another embodiment of a magnetic chuck with a protrusion to magnetically hold and align an optical memory card, only a portion of which is shown in FIG. 12. As shown in FIG. 12, chuck 712″ holds CD card 700″, which does not include a metal element, with the aid of a top chuck 712a″. Top chuck 712a″ and chuck 712″ may be magnetically attracted to hold CD card 700″. A protrusion 713″ from chuck 712″ engages a center hole 731″ to ensure alignment of CD card 700″. Protrusion 713″ may extend into top chuck 712a″. It is understood, of course, that to load or unload CD card 700″, top chuck 712a″ must be separated from chuck 712″.

In addition to well known reading lasers and detectors 711 for reading the CD media layer, driver 701 further includes an additional laser source 718 and photo detector 724. Laser source 718 and photo detector 724 are used to detect if CD card 700 has a DOE 740 and if DOE 740 is authentic. Laser source 718 produces a coherent beam of light, for example at a wavelength of 650 mm. Collimating lens 720 is positioned in the path of light beam 722 to collimate light beam 722. DOE 740 diffracts light beam 722 into diffracted beams 723 as light beam 722 is reflected off of the surface of DOE 740. Diffracted beams 723 are then detected by photo detector 724 located to receive diffracted beams 723. Photo detector 724 can be a quad detector that uses standard signal detection in order to read or determine the DOE's 740 authenticity. In this manner the driver 701 determines if CD card 700 is authentic by first looking to see if a DOE 740 is present, and if it is present it will determine the validity of the DOE 740. If a DOE 740 is not on the CD card 700 or it is not a valid DOE 740, the driver 701 will not read the card. Of course, if desired, a broadband light source may be used in place of laser source 718.

It should be understood that the arrangement of the various components of driver 701 are illustrative only and that they may be oriented or configured differently within the present invention as should be recognized by one skilled in the art. For example, CD card 700 could be placed on support 710 with the DOE 740 on an opposite surface such that the laser source 718 and photo detector 724 would be placed above the CD card opposite the drive motor 716. Also, different configurations of the support 710 and magnetic chuck 712 can be used with the general purpose of using the magnetic chuck 712 to hold and drive CD card 700 as opposed to a spindle used in a conventional driver.

The above detailed descriptions are provided to illustrate specific embodiments of the present invention and are not intended to be limiting. Numerous modifications and variations within the scope of the present invention are possible. For example, FIGS. 2A-2C, 3A-3c, 6A, and 6B show different embodiments of the optical memory card and that any combination of DOE, data zone, and information carrying layer configurations may advantageously be used. Also, FIGS. 4A-4D, 5A, and 5B show different embodiments of the optical memory card and that any combination and location of metal elements, hole, notches, or protrusions may advantageously be used. Therefore, the spirit and scope of the appended claims should not be limited to the description of the versions depicted in the figures.

We claim:

1. An optical memory card comprising:
a substrate having a data zone;
an information carrying layer formed on said substrate over said data zone;
at least one diffractive optical element positioned on the substrate; and
a metal element coupled to said substrate, wherein said metal element magnetically holds said substrate to a chuck.

2. The optical memory card of claim 1, further comprising a protective layer over said information carrying layer and said at least one diffractive optical element.

3. The optical memory card of claim 1, wherein said at least one diffractive optical element is embossed in said substrate and is positioned within said data zone.

4. The optical memory card of claim 1, wherein said at least one diffractive optical element is embossed in said substrate and is positioned outside of said data zone.

5. The optical memory card of claim 1, wherein the information carrying layer formed on said body comprises a reflective layer.

6. The optical memory card of claim 1, wherein said information carrying layer includes at least one of a CD and DVD layer.

7. The optical memory card of claim 1, wherein said data zone has an inner radius of approximately 12 mm.

8. The optical memory card of claim 1, wherein said metal element is a disk.

9. The optical memory card of claim 1, wherein said metal element includes an integrally formed alignment hole.

10. The optical memory card of claim 1, wherein said metal element includes an integrally formed alignment protrusion.

11. The optical memory card of claim 1, wherein said substrate includes an integrally formed alignment hole.

12. The optical memory card of claim 1, wherein said substrate includes an integrally formed alignment protrusion.

13. The optical memory card of claim 1, wherein said card is formed in a rectangular shape.

14. The optical memory card of claim 1, wherein the information carrying layer is formed on a first side of said substrate and at least one diffractive optical element is positioned on an opposite second side of the substrate.

15. A memory card comprising:
a substrate having a data zone encircling the center of said substrate;
an information carrying layer covering said data zone; and
a metal element coupled to said substrate, wherein said metal element magnetically holds said substrate to a chuck.

16. The memory card of claim 15, wherein said metal element is a disk.

17. The memory card of claim 15, wherein said metal element has a thickness equal to the thickness of said substrate.

18. The memory card of claim 15, wherein said metal element includes an integrally formed hole.

19. The memory card of claim 15, wherein said metal element includes an integrally formed protrusion.

20. The memory card of claim 15, wherein said substrate includes an integrally formed alignment hole.

21. The optical memory card of claim 15, wherein said substrate includes an integrally formed alignment protrusion.

22. The memory card of claim 15, further comprising at least one diffractive optical element in the substrate.

23. The memory card of claim 22, wherein said at least one diffractive optical element is embossed in said substrate and is positioned within said data zone.

24. The memory card of claim 22, wherein said at least one diffractive optical element is embossed in said substrate and is positioned outside of said data zone.

25. The memory card of claim 20, wherein the information carrying layer is formed on a first side of said substrate and at least one diffractive optical element is positioned on an opposite second side of the substrate.

26. The memory card of claim 15, wherein said information carrying layer includes at least one of a CD and DVD.

27. A memory card comprising:
a substrate having a data zone;
an information carrying layer formed on said substrate over said data zone; and
at least one diffractive optical element in the substrate.

28. The memory card of claim 27, further comprising a metal element coupled to said substrate.

29. The memory card of claim 28, wherein said metal element is centrally located on said substrate.

30. The memory card of claim 28, wherein said metal element is a disk.

31. The memory card of claim 28, wherein said metal element has a thickness equal the thickness of said substrate.

32. The memory card of claim 28, wherein said metal element includes an integrally formed hole.

33. The memory card of claim 28, wherein said metal element includes an integrally formed protrusion.

34. The memory card of claim 28, wherein said at least one diffractive optical element is embossed in said substrate and is positioned within said data zone.

35. The memory card of claim 28, wherein said at least one diffractive optical element is embossed in said substrate and is positioned outside of said data zone.

36. A method for manufacturing a memory card comprising:
embossing a substrate with a desired diffractive optical element design;
embossing grooves on said substrate; and
providing an information carrying layer over the grooves embossed on said substrate.

37. The method for manufacturing a memory card of claim 36, wherein said grooves are circular grooves.

38. The method for manufacturing a memory card of claim 36, wherein said grooves are spiral grooves.

39. The method for manufacturing a memory card of claim 36, wherein embossing said diffractive optical element design and said grooves is done with a single stamp.

40. The method for manufacturing a memory card of claim 36, wherein said information carrying layer comprises at least one of a CD and a DVD layer.

41. The method for manufacturing a memory card of claim 36, further comprising layering a protective coating over the information carrying layer and the diffractive optical elements.

42. The method for manufacturing a memory card of claim 36, wherein the at least one diffractive optical element is embossed within said grooves.

43. The method for manufacturing a memory card of claim 36, wherein the at least one diffractive optical element is embossed outside of said grooves.

44. The method for manufacturing a memory card of claim 36, further comprising a metal element for holding said card to a magnetic chuck coupled to said substrate.

45. The method for manufacturing a memory card of claim 44, wherein said metal element is coupled at the center of said substrate.

46. A driver for reading an optical memory card having an optical information carrying layer, said optical memory card having a metal element, said driver comprising:
a magnetic chuck driven by a motor, wherein said metal element of said memory card is magnetically held adjacent to said magnetic chuck and said memory card is rotated; and
a reading laser for reading information from said optical memory card.

47. The driver of claim 46, further comprising at least one hole to engage with and center said memory card.

48. The driver of claim 46, further comprising at least one protrusion to engage with and center said memory card.

49. The driver of claim 46, wherein said light source is a laser.

50. The driver of claim 46, further comprising a collimating lens positioned in the path of said light beam.

51. The driver of claim 46, further comprising a light source positioned to create a light beam incident upon a diffractive optical element of the memory card, and
a photodetector positioned to receive light diffracted from said diffractive optical element.

52. The driver of claim 51, wherein said light source is a laser.

53. A driver for reading and authenticating an optical memory card having an optical information carrying layer comprising:
a magnetic chuck driven by a motor, wherein a memory card is magnetically held adjacent to said magnetic chuck and rotated;
a light source positioned to create a light beam incident upon a diffractive optical element of the memory card;
a photodetector positioned to receive light diffracted from said diffractive optical element; and
a reading laser for reading information from said optical memory card.

54. The driver of claim 53, wherein said light source is a laser.

55. The driver of claim 53, further comprising at least one hole to engage with and center said memory card.

56. The driver of claim 53, further comprising at least one protrusion to engage with and center said memory card.

57. A memory card comprising:
a substrate having a center hole;
at least one groove encircling said center hole in said substrate; and
an information carrying layer over said at least one groove to form a data zone, said data zone having an inner diameter of approximately 24 mm or less.

58. The memory card of claim 57, wherein said center hole is approximately 3 mm or less.

59. The memory card of claim 57, further comprising a metal element coupled to said substrate, wherein said metal element magnetically holds said substrate to a chuck.

60. The memory card of claim 57, further comprising at least one diffractive optical element in the substrate.

61. The memory card of claim 60, wherein said at least one diffractive optical element is embossed in said substrate and is positioned within said data zone.

62. The memory card of claim 57, wherein said data zone has an outer diameter of approximately 52 mm.

63. The memory card of claim 57, wherein said information carrying layer extends to approximately the edges of said memory card.
